(19) United States
(12) Patent Application Publication
(10) Pub. No.: US 2002/0102016 A1
(43) Pub. Date: Aug. 1, 2002

(54) Image processing method and device

(75) Inventors: Nobuto Yamazaki, Kunitachi-shi (JP); Shinichi Baba, Fuchu-shi (JP); Kenji Sugawara, Kokubunji-shi (JP)

Correspondence Address: KODA & ANDROLIA, 2029 Century Park East, Suite 3850, Los Angeles, CA, 90067-3024, US

(73) Assignee: KABUSHIKI KAISHA SHINKAWA

(21) Appl. No.: 10/058,890

(22) Filed: Jan. 25, 2002

(30) Foreign Application Priority Data
Jan. 26, 2001 (JP) 2001-017842

(51) Int. Cl. G06K 9/00

(52) U.S. Cl. 382/146; 382/291

(57) ABSTRACT

Image processing for detecting the position of a workpiece such as a semiconductor device employed in, for instance, wire boding including the step of obtaining first position (coordinates) of leads by way of imaging the leads individually after positioning the leads of a sample workpiece one at a time in the center of visual field of a camera, the step of obtaining second position (coordinates) of such respective leads by imaging all the leads that are in the visual field at one time, and the step of storing the differences between the first position and the second position in memory as a correction amount. Upon actual product manufacturing, the correction amount is added to the position (coordinates) of the respective leads of the workpiece obtained by collective imaging of the leads, thus obtaining the actual bonding point (coordinates) for the workpiece.

### BACKGROUND OF THE INVENTION

1. Field of the Invention

The present invention relates to an image processing method and device and more particularly to a method and device for detecting the position of an object by image processing.

2. Prior Art

Position detection that uses an image processing technology is widely used in the field of manufacturing of an electronic component, such as semiconductor device assembly apparatuses, etc. For example, in a wire bonding apparatus, a wire, which is a gold wire, for instance, is bonded so that a plurality of bonding pads consisting of aluminum, etc. on a semiconductor chip and a plurality of leads consisting of conductors which are formed so as to surround the semiconductor chip are connected one at a time. Prior to this bonding operation, the positions of the bonding points which are the points where bonding is to be performed are detected with an image processing technology such as pattern matching, etc.

The conventional way to detect the positions of bonding points will be first described with reference to a wire bonding apparatus that has a structure similar to that shown in FIG. 1. In this wire bonding apparatus, a camera 7 fastened to an XY table 1 is moved in the horizontal direction relative to a semiconductor device 14 by the operation of this XY table 1

More specifically, the XY table 1 that includes the camera 7 is moved while the image from the camera 7 that takes images of the semiconductor device 14 is displayed on the display screen 22 of a monitor 39 (see FIG. 4), so that, as seen from FIG. 4, the visual field is moved, and the center point 32a of cross marks 32 that indicate the center of the visual field displayed on the display screen 22 is aligned with a point that is located at an approximate center of a lead L (with respect to the direction of width of the lead L) and at a specified distance from the tip end of the lead L.

Then, an input operation such as pressing the input switch of a manual input means 33, etc, is performed, so that image information (i.e. the width of the lead, etc.) is acquired from an image of the region surrounded by a rectangular reticle mark 42 centered on the center point 32a and then stored. The coordinates on the XY table 1 in this case are stored in a data memory 36 as the position of the lead L. This operation is performed for all the leads L and pads P.

For the pads P, the above input operation is performed with the center point 32a of the cross marks 32 aligned with a point located at an approximate center of each pad P.

Further for the pads, two points from the pads P located at opposite comers of the substantially rectangular semiconductor chip 14a or from areas in the vicinity of such pads (e.g., the center points Pg of the pads P positioned in the corner portions of the semiconductor chip 14a), and two points consisting of points on the nearby leads L or patterns having a unique shape formed as integral portions of these leads L (e.g., the center points Lg of reference patterns Ls formed as extensions from the leads L), are selected as alignment points. Then, image acquisition and registration of the coordinates of the alignment points for the pads are performed by performing a similar input operation as that for the leads.

In run time processing (i.e., processing at the time of producing or manufacturing products), a new semiconductor device 14 that is to be detected is set in place, and the XY table 1 is moved by the control of the control section 34 so that the area in the vicinity of the registered alignment points becomes the visual field of the camera 7. Then, the camera 7 acquires an image of the semiconductor device 14, and the amounts of positional deviation between the registered alignment points and points that correspond to these alignment points in the new semiconductor device 14 are determined. Further, the tentative bonding points of the respective pads P and leads L (i.e., the points where points located at the approximate centers (with respect to the direction of width) of the leads L of the sample semiconductor device 14 and at a specified distance from the tip ends of these leads L are positioned when the alignment points in the sample semiconductor device 14 are superimposed on points corresponding to the alignment points in the semiconductor device 14 that is the object to be detected) are calculated from the positions of the new alignment points with the positions of the respective pads P and leads L relative to the alignment points at the time of registration being preserved.

Furthermore, for the leads L, the visual field of the camera 7 is moved so that the calculated tentative bonding point of each lead becomes the center point 32a, and the positions of the leads in the semiconductor device 14 that is to be detected are individually detected and corrected (this process is referred to hereafter as “lead correction”) by performing edge detection of the images using the lead image information for the images of the individual leads acquired from these positions. These points are then designated as the actual bonding points. The performance of this lead correction takes into account the fact that the positional deviation (individual difference) between individual semiconductor devices 14 is large due to the fact that the leads L are extremely slender and susceptible to bending in recent semiconductor devices 14.

However, when the camera 7 is moved to the tentative bonding position of a lead L for the purpose of performing lead correction separately for all of the leads L, considerable time is required for this operation and the individual imaging operations. The productivity thus drops.

On the other hand, there is another method in which, so as to accomplish high-speed operation, the time required for the movement operation and imaging of the camera 7 is reduced by performing respective edge detections for all of the leads L in the visual field of the camera 7 utilizing an image of the object to be detected obtained by a single imaging operation of the camera 7. However, there is optical system distortion in the peripheral areas of the visual field (approximately 3 mm Φ) of the camera. Accordingly, positional error generates. More specifically, the positions of the leads L in the actual space as shown in FIG. 8 are detected as different positions in the image space accompanied by distortion of the optical system as shown in FIG. 9.

Furthermore, there are also problems caused by the directionality of the illumination in the peripheral portions of the visual field. In other words, even in a case where the width of the leads L is α1, and the positional coordinates of the center point with respect to the direction of width are (Lax, Lay), the portions of the leads L located on the lower sides of the leads L are not illuminated by the illuminating light when the direction of the illuminating light is β as shown in FIG. 6. In the camera (not shown) positioned directly above the lead L in FIG. 6, the width of the lead is detected as α2, and the center point with respect to the direction of width is detected as (Lbx, Lby). Since the light source used for imaging is ordinarily installed as an integral part of the camera 7, in other words, since the relative position of the light source with respect to the camera 7 does not vary, the positional relationship between the lead L and the light source varies according to the individual lead L in cases where the positions of all of the leads L in the visual field are detected utilizing an image obtained by a single imaging operation, thus causing positional error to be generated.

Japanese Patent Application Laid-Open (Kokai) No. S63-274142, for instance, discloses a method of eliminating the effects of distortion of the optical system in the peripheral portions of the visual field. In this method, a transformation equation between the coordinates of an absolute lattice of known dimensions and coordinates obtained from an image accompanied by distortion of the optical system is determined, and the coordinates obtained from the image are subsequently corrected using this equation.

Furthermore, a method based on a similar concept utilizing correction samples of known dimensions is disclosed in Japanese Patent Application Laid-Open (Kokai) No. H08-285533.

In these methods, however, the amount of calculation required in order to determine a transformation equation for the positional coordinates of all of the lattice points in an absolute lattice or correction samples is large. Also, it is necessary to prevent deterioration such as contamination and deformation, etc. of the absolute lattice or correction samples used over a long period of time. Furthermore, the disclosed method cannot solve the above-described problem deriving from the directionality of the illumination.

### SUMMARY OF THE INVENTION

Accordingly, the object of the present invention is to provide an image processing method and apparatus that increases the speed and precision of position detection in the run time without depending on an absolute lattice or correction samples.

The above object is accomplished by a unique process of the present invention for an image processing method that, by way of using an imaging device for imaging an electronic component having numerous leads, detects the positions of a plurality of leads of the electronic component, which is an object to be detected, based upon an image obtained by imaging the electronic component as a sample and upon an image obtained by imaging the electronic component as an object to be detected; and the unique process of the present invention is comprised of the steps of:

calculating a first position (or position A) of one or a few leads among the leads in the sample by way of using an image acquired with such one or a few leads disposed in a specified region that involves a center point of a visual field of the imaging device,

calculating second positions (or position B) of such one or a few leads by way of using an image obtained by collectively imaging a plurality of leads that include such one or a few leads and other leads in the sample,

holding a relationship between the first position and the second position as a correction amount for such one or a few leads,

calculating third positions (or position C) of such one or a few leads by way of using an image obtained by collectively imaging a plurality of leads that include such one or a few leads and other leads in the object to be detected, and

calculating fourth positions (or position E) of such one or a few leads based upon the third position and the correction amount

In the above method of the present invention, the position A of the above one or a few leads among the plurality of the leads in the sample electronic component is first calculated using an image acquired with such one or a few leads disposed in a specified region that involves the center point of the visual field of the camera. Furthermore, the position B of such one or a few leads is calculated using an image that is obtained by collectively imaging a plurality of leads that include such one or a few leads as well as other leads in the sample. Either the calculation of the position A or the calculation of the position B is performed first. Then, the relationship between the position A and the position B is stored or held as a correction amount D for such one or a few leads.

In the run time, the position C of such one or a few leads are calculated using an image obtained by imaging at one time a plurality of leads that include such one or a few leads as well as other leads in the electronic component that is the object to be detected. Then, based upon the calculated position C and the held correction amount D, the position E of such one or a few leads is calculated.

Thus, in the present invention, the relationship between the position A of a particular lead (or the above one or a few leads) calculated using an image acquired with such a particular lead disposed in a specified region that involves the center point of the visual field of the camera, and the position B of such a particular lead calculated using an image obtained by collectively imaging at one time a plurality of leads that include such a particular lead and other leads, is held beforehand as a correction amount for such a particular lead. Accordingly, the effects of distortion by an optical system in the peripheral portions of the visual field can be corrected by the correction amount.

In the conventional examples that use an absolute lattice or correction samples, the correction amount must be calculated for all of the lattice points in the absolute lattice or correction samples. However, in the present invention, calculation for the correction amount is made only for the target point of the respective leads. Accordingly, the amount of calculation and amount of data required are small, and as a result, the method of the present invention is suitable for high-speed processing.

In the run time, the position C of such a particular lead (or the above one or a few leads) are calculated using an image obtained by imaging at one time a plurality of leads that include such a particular lead and other leads. Accordingly, the positions of all of the leads L in the visual field are detected using an image obtained by a single imaging operation. Thus, the time required for the movement operation and imaging operation of the camera is minimized, and a high-speed process is accomplished.

In the above method of the present invention, a specified region that involves the center point of the visual field can be illuminated by light during the execution of the imaging.

By way of such illuminations with light, the relationship between the position A detected with the particular lead (or the above one or a few leads) disposed in a specified region that involves the center point of the visual field, in which the effect of illumination directionality is small, and the position B detected with the particular lead (or the above one or a few leads) disposed in the peripheral portions of the visual field, where the effect of illumination directionality is large, can be corrected by the correction amount D. Thus, not only the effects of distortion of the optical system but also the effects of illumination directionality can be eliminated.

The above object is further accomplished by a unique structure of the present invention for an image processing device that, by way of using an imaging device for imaging an electronic component having numerous leads, detects the positions of a plurality of leads of the electronic component, which is an object to be detected, based upon an image obtained by imaging the electronic component as a sample and upon an image obtained by imaging the electronic component as an object to be detected; and the unique structure of the present invention is comprised of:

a means that calculates a first position (or position A) of one or a few leads among leads in the sample by way of using an image acquired with such one or a few leads disposed in a specified region that involves a center point of a visual field of the imaging device,

a means that calculates a second position (or position B) of such one or a few leads by way of using an image obtained by collectively imaging a plurality of leads that include such one or a few leads and other leads in the sample,

a means that holds a relationship between the first position and the second position as a correction amount for such one or a few lead,

a means that calculates a third position (or position C) of such one or a few leads by way of using an image obtained by collectively imaging a plurality of leads that include such one or a few leads and other leads in the object to be detected, and

a means that calculates a fourth position (or position E) of such one or a few leads based upon the third position and the correction amount.

With the above structure for the image processing device, the effects of distortion by an optical system in the peripheral portions of the visual field can be corrected by the correction amount. Also, the amount of calculation and amount of data required are small, and as a result, the image processing device of the present invention is suitable for high-speed processing.

In the above structure, a light source that illuminates a specified region that involves the center point of the visual field during performances of imaging can be further provided.

With the use of the light source, not only the effects of distortion of the optical system but also the effects of illumination directionality can be eliminated.

### BRIEF DESCRIPTION OF THE DRAWINGS

FIG. 1 is a block diagram of the schematic structure of a bonding apparatus in which the image processing method and device of the present invention is employed;

FIG. 2 is a flow chart of one example of the registration processing for a new electronic component (semiconductor device) according to the present invention;

FIG. 3 is a flow chart of one example of the processing in the run time in the present invention;

FIG. 4 is an explanatory diagram that illustrates the registration processing for a new semiconductor device according to the present invention;

FIG. 5 is an explanatory diagram that illustrates the processing in the run time according to the present invention;

FIG. 6 shows a lead in cross-section illustrating the positional error caused by illumination directionality along with the function of the embodiment of the present invention;

FIG. 7 is a top view of a lead illustrating the positional error caused by illumination directionality along with the function of the embodiment of the present invention;

FIG. 8 is an explanatory diagram that illustrates an image of a lead in actual space; and

FIG. 9 is an explanatory diagram that illustrates an image of a lead in the image space accompanied by distortion of an optical system.

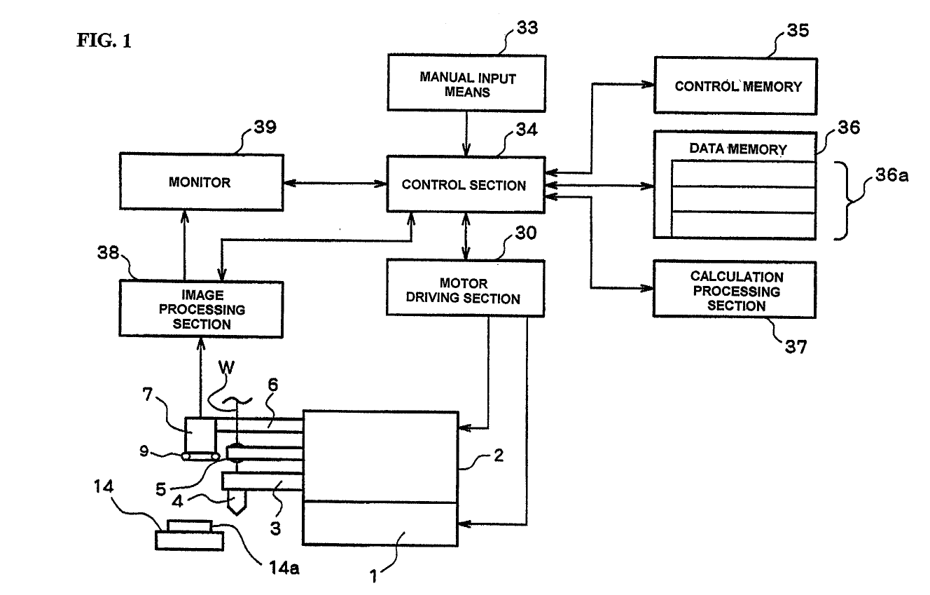

### DETAILED DESCRIPTION OF THE INVENTION

Embodiments of the present invention will be described below with reference to the accompanying drawings.

In Figure that shows a bonding apparatus in which the present invention is employed, 1, a bonding arm 3 is disposed on a bonding head 2 that is mounted on an XY table 1, and a tool 4 is attached to the tip end portion of the bonding arm 3. The bonding arm 3 is driven in the vertical direction by a Z-axis motor (not shown). A damper 5 that holds a wire W is disposed above the bonding arm 3. The lower portion of the wire W is passed through the tool 4. The tool 4 in this embodiment is a capillary.

A camera arm 6 is attached to the bonding head 2, and a camera 7 is fastened to the camera arm 6. The camera 7 takes images of a semiconductor device 14 on which a semiconductor chip 14a, etc. is mounted. A ring-form light source 9 consisting of light-emitting diodes, etc., is integrally fastened to the camera 7 so that the light source 9 surrounds the light-receiving part (not shown) of the camera 7. The light source 9 is disposed so that the center point of the ring-form shape of the light source coincides with the optical axis of the camera 7. Accordingly, the semiconductor device 14 is illuminated at an inclination from above, from the entire circumference toward the center point of the visual field of the camera 7.

The XY table 1 is accurately moved in the X direction and Y direction, which are mutually perpendicular coordinate axis directions in the horizontal plane, by means of XY table motors (not shown) consisting of two pulse motors, etc., installed in the vicinity of the XY table 1. The structure described so far is known in prior art.

The XY table 1 is driven, via a motor driving section 30 and the XY table motors, by way of the commands from a control section 34 that is, for instance, a microprocessor. The images taken by the camera 7 are converted into image data that consist of an electrical signal. This image data is processed by an image processing section 38 and inputted into a calculation processing section 37 via the control section 34. Various calculations including calculations involved in position detection (described later) are performed in the calculation processing section 37, and programs and data used for such calculations are temporarily held in a control memory 35. A manual input means 33 and a monitor 39 are connected to the control section 34. A manual input means 33 is preferably at least a pointing device such as a mouse input device (called “mouse”), etc., equipped with a direction-indicating function in the X and Y directions and a setting signal input function based on an input button. The manual input means 33 can be a known keyboard equipped with a character input function.

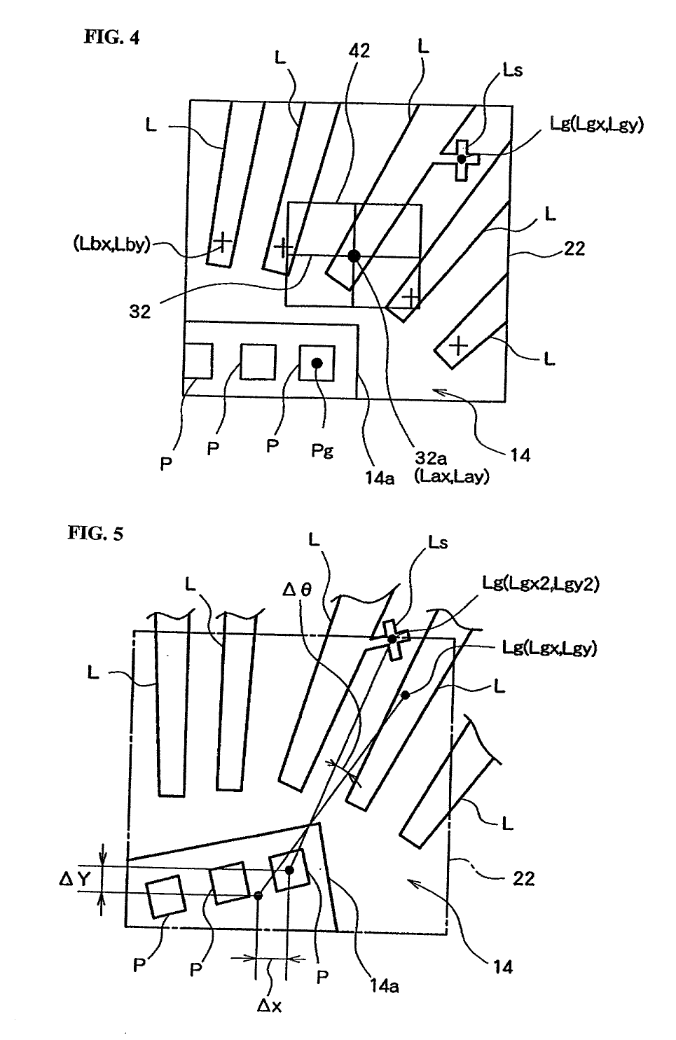

The monitor 39 is, for instance, a CRT (cathode ray tube) or a liquid crystal display device. Images acquired by the camera 7, associated coordinate values, numerical values such as magnifications, etc. and various types of character messages (described later), etc. are displayed on the display screen 22 of the monitor 39 based upon the output of the control section 34. In the position detection process, as shown in FIG. 4, cross marks 32 which indicate the center of the visual field, and a rectangular reticle mark 42 which is displayed and stored in memory as a mark that indicates a region within the visual field that surrounds the abovementioned cross marks 32, are displayed on the display screen 22. The intersection point of the vertical line and horizontal line in the cross marks 32 is the center point 32a.

The data memory 36 is a known random-access memory, a hard disk drive, etc. that allows the reading and writing of data. A data library 36a is accommodated in the storage region of the data memory 36. Template images (described later), past values such as detected position coordinates, etc., default values which are the initial states of these values, and various types of setting values used in other operations of the image processing device, are stored in this data library 36a. Various types of data are stored (as will be described later) by signals from the control section 34.

In the shown embodiment, the registration of alignment points and respective bonding points, and the storage in memory of the correction amount, are first performed as registration processing for a new semiconductor device 14. Then, position detection by pattern matching and correction by means of the correction amount are performed as processing in the run time.

The description here will focus on the detection of the positions of the leads L, and the detection of the positions of the pads P will not be described in detail.

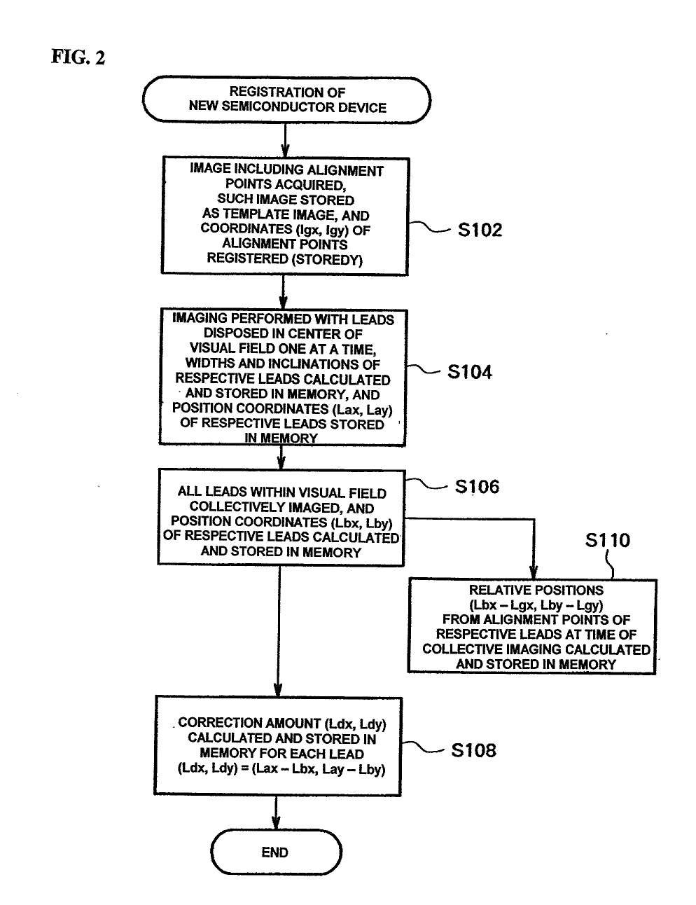

FIG. 2 is a flow chart of the registration processing for a new semiconductor device 14 that is going to be processed.

First, by way of imaging a region that involves the alignment points, the region that involves the alignment points as a template image in memory and a registration of the alignment points are stored (S102). For the alignment points, two points from the pads P located at opposite corners of a substantially rectangular semiconductor chip 14a or two points from areas near these pads are selected as these alignment points. Also, two points from the nearby leads L or patterns having a unique shape formed as integral portions of these leads L are selected as these alignment points. For example, as seen from FIG. 4, the center point Pg of the pad P positioned in one corner of the rectangular semiconductor chip 14a and the center point (not shown) of the pad positioned in the opposite corner (not shown) of the semiconductor chip 14a are selected as the alignment points. In addition, for example, the center point Lg of the reference pattern Ls that is of the lead L and is formed as an extension from the lead L near the corner of the center point Pg and the center point (not shown) of another lead that is positioned near the opposite corner of the semiconductor chip 14 are also selected as the alignment points.

The template image of the region thus imaged is used in pattern matching in the run time operation (described later).

The registration of the alignment points is realized in the following manner: while an image from the camera 7 which has imaged the semiconductor chip 14a is displayed on the display screen 22 of the monitor 39, by operating the manual input means 33, the visual field is moved by moving the XY table 1 to which the camera 7 is fastened, so that the center point 32a of cross marks 32 that indicate the center of the visual field displayed on the display screen 22 of the monitor 39 is aligned with each alignment point, and in this state, an input operation is performed by, for instance, pressing the input switch of the manual input means 33, so that the coordinates of the center point 32a on the XY table 1 in this case are stored in the data memory 36.

The position coordinates of the alignment points Lg on the side of the leads are defined as (Lgx, Lgy). The various types of position coordinates described below indicate respective distances in the X and Y directions from an FOV (filed of view) position, which will be described later.

Next, the XY table 1 is driven by the output of the control section 34, and the camera 7 takes the image of each one of leads L positioned one at a time in the center of the visual field of the camera 7. The widths and inclinations of the respective leads L are calculated by edge detection based upon these images, and these values are stored in the data memory 36. Furthermore, the position coordinates (Lax, Lay) of the respective leads L at the time of the individual imaging operations are stored in the data memory 36 (S104). The position coordinates (Lax, Lay) of each lead L (the position A) are the coordinates of a point that is located at the center of each lead L with respect to the direction of width and that is located at a specified distance from the tip end of the lead L.

Next, all of the leads L within the visual field are imaged at one time or collectively. Then, the position coordinates (Lbx, Lby) of the respective leads L (the position B) are calculated based upon the image obtained by this collective imaging, and these coordinates are stored in the data memory 36 (S106). The position coordinates (Lbx, Lby) of each lead L are the coordinates of a point that is located at the center of each lead L with respect to the direction of width and that is located at a specified distance from the tip end of the lead L.

The position of the camera 7 at the time of this collective imaging, i.e., the position of the center point 32a of the cross marks 32 at the time of this collective imaging is referred to as the “FOV position”. “FOV” is an abbreviation of the initial letters of “field of view”. The FOV position is selected so that an operator manually designates a position in which a specified number of leads L are involved within the visual field of the camera 7. The FOV position is also selected by way of designating automatically by appropriate image processing a position in which a specified number of leads L are involved within the visual field of the camera 7. The position coordinates of the absolute position of the selected FOV position with respect to the XY table 1 are stored in the data memory 36.

Next, the position coordinates (Lgx, Lgy) of the alignment points are subtracted from the calculated position coordinates (Lbx, Lby) of the respective leads L obtained by collective imaging. The resulting values are stored in the data memory 36 as the relative positions (Lbx-Lgx, Lby-Lgy) with respect to the alignment points.

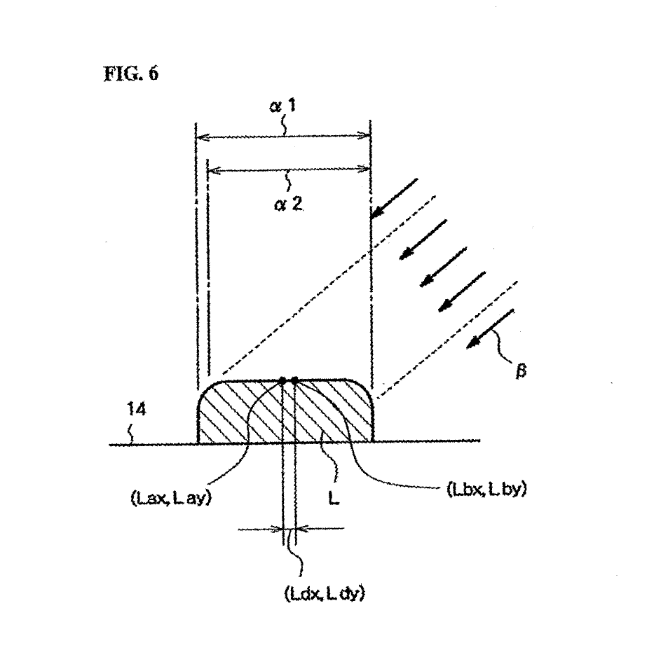

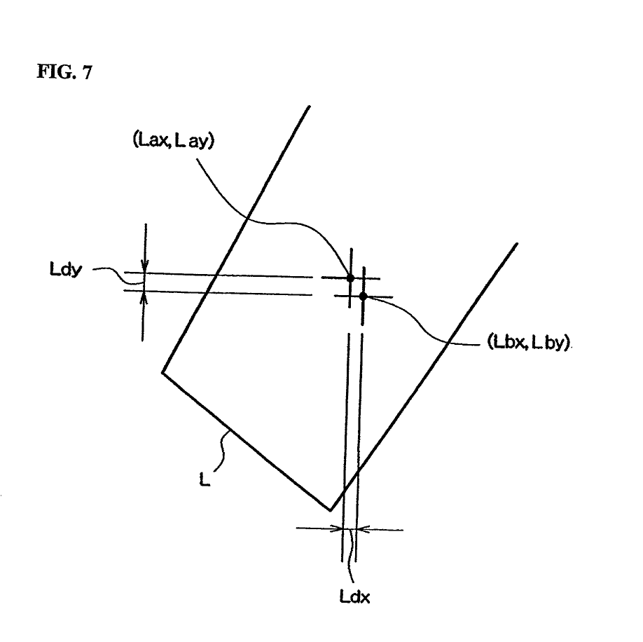

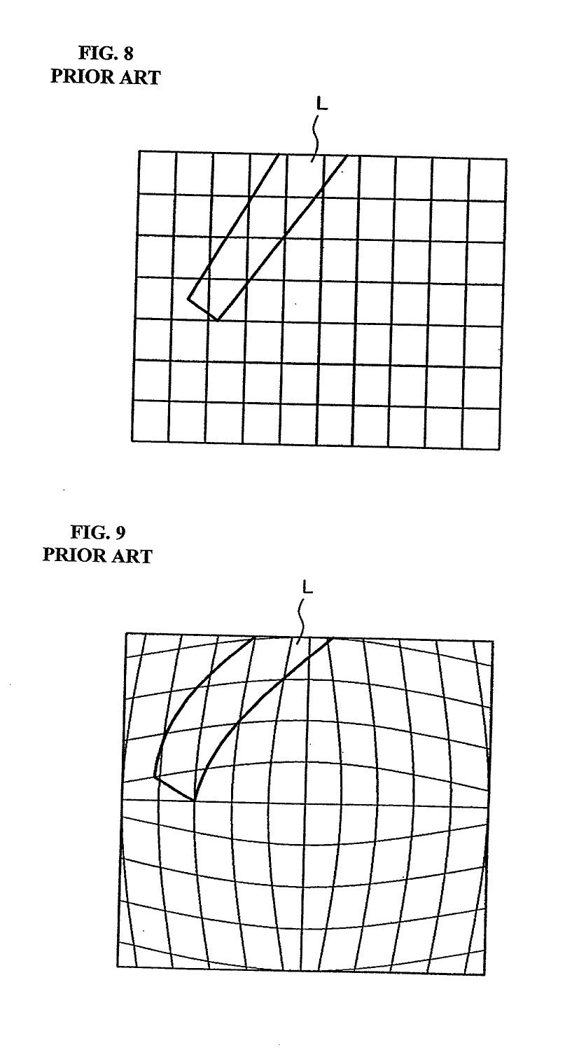

Furthermore, the position coordinates (Lbx, Lby) of the respective leads L obtained by collective imaging are subtracted from the position coordinates (Lax, Lay) of the respective leads obtained by individual imaging, thus calculating the correction amount (Ldx, Ldy)=(Lax-Lbx, Lay-Lby), and this value is stored in the data memory 36 (S108). The correction amount (Ldx, Ldy) is as shown in FIGS. 6 and 7.

The above processing is performed at the time of registration for a new semiconductor device 14.

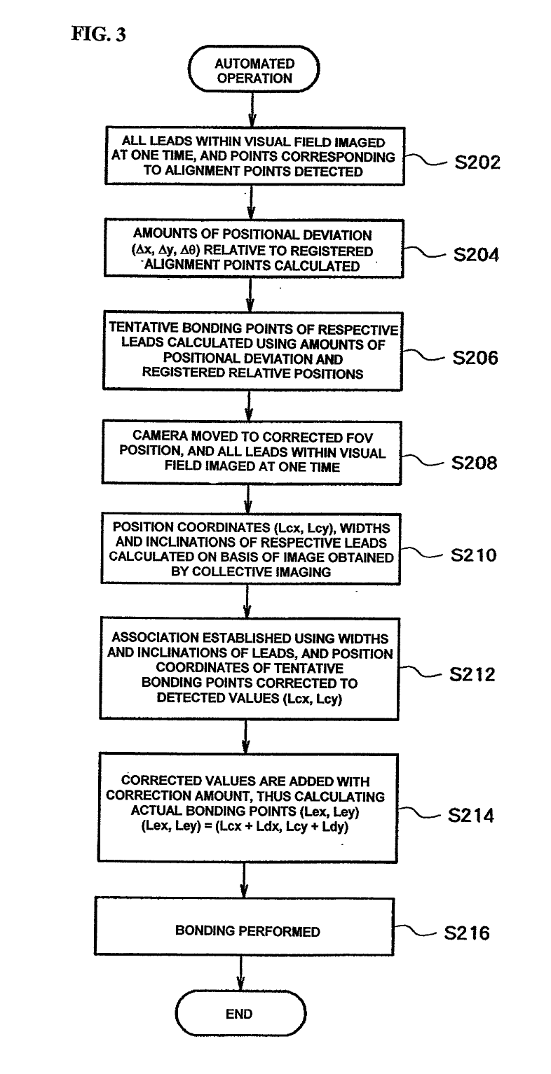

The run time processing is shown in FIG. 3 and FIGS. 5 through 7.

First, with the new semiconductor device 14 that is the object to be detected set in place, all of the leads L within the visual field are imaged by the camera 7 from the FOV position, and the position (Lgx2, Lgy2) of a point corresponding to the alignment point is detected by pattern matching using the template image stored in memory in the previous step S102 (S202). For example, this pattern matching is performed by searching for the point where the normalized correlation value with the template image shows a maximum value.

Next, the amounts of positional deviation (Δx, Δy, Δθ) between the detected position and the registered alignment points are calculated (S204).

Then, the tentative bonding point of each lead L is calculated using the calculated amount of positional deviation (Δx, Δy, Δθ) and the previously registered relative positions (Lbx-Lgx, Lby-Lgy) (S206). These tentative bonding points are the points where points located in the centers (with respect to the direction of width) of the leads L of the sample semiconductor device 14 and at a specified distance from the tip ends of the leads L are positioned when the alignment point Lg (Lgx, Lgy) in the sample semiconductor device 14 is superimposed on the point Lg (Lgx2, Lgy2) corresponding to the alignment point in the semiconductor device 14 which is the object to be detected. Accordingly, individual differences such as bending of the leads L, etc., in the semiconductor device 14 that is to be detected are not involved in these tentative bonding points.

Next, the position coordinates of the previously registered FOV position are corrected by the amount of positional deviation (Δx, Δy, Δθ), the camera 7 is moved to the corrected FOV position, and the leads L within the visual field are all imaged at the same time from the FOV position (S208).

Further, image processing such as edge detection, etc., is performed on the image of the leads L obtained by collective imaging from the FOV position, and the position coordinates (Lcx, Lcy) of the respective leads L (the position C) and widths and inclinations of the respective leads L are calculated (S210). At this point, it is not specified which leads L are the respective leads L.

Next, the calculated inclinations of the respective leads L are corrected by the above-described amount of positional deviation Δθ in the rotational direction. Furthermore, using the widths and corrected inclinations of the respective leads L, reference is made in the data memory 36 to the widths and inclinations of the respective leads L previously stored in memory in step S106, and a search is made for leads L in which these widths and inclinations following correction agree within a specified permissible range. Then, an association is made in order to establish which leads L in this semiconductor device 14 (which is the object to be detected) correspond to which leads L in the sample semiconductor device 14. Then, based upon this association, the position coordinates of the tentative bonding points in the respective leads L are replaced by the position coordinates (Lcx, Lcy) of the respective leads L calculated in step S210. As a result, the position coordinates of the tentative bonding points are corrected to the detected values (S212).

Next, the correction amount (Ldx, Ldy) previously stored is added to the corrected values (Lcx, Lcy), thus calculating the position coordinates (Lex, Ley)=(Lcx+Ldx, Lcy+Ldy) of the actual bonding point (the position E) (S214).

Then, bonding is performed at the position coordinates (Lex, Ley) of the actual bonding points thus calculated (S216). In concrete terms, the XY table 1 is driven by the output of the control section 34 so that the tool 4 is moved to the respective actual bonding points, and the wire W is bonded by the application of heat and pressure and the application of an ultrasonic vibration.

As seen from the above, in the above embodiment, the position (Lax, Lay) of one lead L among the leads L in a sample semiconductor device 14 is calculated using an image that is acquired with this single lead L disposed in the center of the visual field of the camera 7 (S 104). Also, the position (Lbx, Lby) of such a single lead L is calculated using an image that is obtained by collectively imaging a plurality of leads L (including such a single lead) in the sample semiconductor device 14 at one time (S106). Either the calculation of the position (Lax, Lay) or the calculation of the position (Lbx, Lby) may be performed first. Then, the relationship between the position (Lax, Lay) and the position (Lbx, Lby) is stored in the data memory (36) as the correction amount (Ldx, Ldy) for the single lead L (S108).

Then, in the run time or actual production time, the position (Lcx, Lcy) of a single lead L in a semiconductor device 14 that is to be detected or processed is calculated using an image that obtained by collectively imaging a plurality of leads (including such a single lead) in the semiconductor device 14 (S210). Then, based upon the calculated position (Lcx, Lcy) and the correction amount (Ldx, Ldy), the position (Lex, Ley) of the single lead L of the semiconductor device 14 is calculated (S214).

As seen from the above, in the shown embodiment, the relationship between the position (Lax, Lay) (the position A) of a single lead L calculated using an image that is acquired with this single lead L disposed in the center of the visual field of the camera 7, and the position (Lbx, Lby) (the position B) of such a single lead calculated using an image that is obtained by imaging a plurality of leads that include such a single lead L and other leads L, is held beforehand as a correction amount (Ldx, Ldy) for such a single lead. Accordingly, the effects of distortion of the optical system in the peripheral portions of the visual field can be corrected using the correction amount (Ldx, Ldy).

Furthermore, in the conventional examples that use an absolute lattice or correction samples, the correction amount must be calculated for all of the lattice points in the absolute lattice or correction samples. In the shown embodiment, on the other hand, it is necessary to calculate or obtain the correction amount (Ldx, Ldy) only for the bonding point that is the target point of the respective leads L. Accordingly, the amount of calculation and amount of data required can be small, being suitable for high-speed processing.

Then, in the run time, the position (Lcx, Lcy) of the single lead L is calculated using an image obtained by collectively imaging a plurality of leads that include such a single lead L and other leads L. Accordingly, the positions of all of the leads L in the visual field can be detected using an image obtained by a single collective imaging of the semiconductor device 14 that is the object to be detected. Consequently, the time required for the movement operation and imaging operation of the camera 7 is minimized, and a high speed processing can be achieved.

In the above embodiment, the light source 9 and camera 7 are provided as an integral unit, and the center of the visual field of the camera 7 is illuminated from the entire periphery during each imaging operation. Accordingly, the relationship between the position (Lax, Lay) detected with the single lead disposed in the center of the visual field, where the effect of illumination directionality is small, and the position (Lbx, Lby) detected with the single lead disposed in the peripheral portion of the visual field, where the effect of illumination directionality is large, can be corrected using the correction amount (Ldx, Ldy). Thus, not only the effects of distortion of the optical system but also the effects of illumination directionality can be eliminated.

Furthermore, in the above embodiment, the differences in the X and Y directions (Lax-Lbx, Lay-Lby) between the position A at coordinates (Lax, Lay) and the position B at coordinates (Lbx, Lby) are taken as the correction amount (Ldx, Ldy) for the lead L. However, the relationship between the position A detected by individual imaging and the position B detected by collective imaging can be specified and held by other forms and by other methods, such as a first-order transformation equation, proportionality constants in the X and Y directions, etc.

In addition, in the above embodiment, the leads L are imaged individually during the calculation of the position A; in other words, the leads L are disposed one at a time in the center of the visual field of the camera 7. However, the leads L can be disposed in the center of the visual field of the camera 7 two or three leads at a time, so that the positions of these two or three leads L are detected individually based upon this image during the calculation of the position A. In this case, the calculation precision of the correction amount tends to be inferior to that obtained in a case where the leads L are imaged one at a time. However, a higher precision can be still obtained compared to a conventional construction in which all of the leads L in the visual field are imaged at one time.

Furthermore, it is not necessary that the position of the lead L during the calculation of the position A coincide completely with the center point 32a of the cross marks 32, which is the center point of the visual field of the camera 7. The inherent effect of the present invention is obtained to a considerable extent as long as the positions of the leads L are in an area which is such that distortion of the optical system of the camera 7 and bias of the illumination directionality can be substantially ignored.

Still further, in the above embodiment, the widths and inclinations of the respective leads L are calculated from edge detection based upon an image obtained by imaging the respective leads L of the sample semiconductor device 14 and then stored in memory; and in the run time an association is established with images of the leads L of the semiconductor device 14 that is to be detected based upon these widths and inclinations. Instead, it is also possible to store images obtained by imaging the respective leads L of the sample semiconductor device 14 and then, using such images as template images, to specify the bonding points in the respective leads L of the semiconductor device 14 that is to be detected by performing pattern matching on the image of the semiconductor device 14.

The above embodiment is described with reference to a process in which mainly bonding points in the leads L are calculated. It is also possible, however, to perform such a process in the detection of positions of pads P or of points that are the object of processing in other members.

In addition, the above embodiment is described for a wire bonding apparatus. The present invention is widely employed for position detection in other types of semiconductor manufacturing apparatuses and in other types of electronic component processing devices using image processing.

1. An image processing method in which a detection of positions of a plurality of leads in an object to be detected is performed using an imaging device which images an electronic component that includes leads, said detection being done based upon an image obtained by imaging said electronic component which is a sample and upon an image obtained by imaging said electronic component which is said object to be detected, said image processing method being comprised of the steps of:
calculating a first position of at least one lead among leads in said sample by way of using an image acquired with said at least one lead disposed in a specified region that involves a center point of a visual field of said imaging device,
calculating a second position of said at least one lead by way of using an image obtained by collectively imaging a plurality of leads that include said at least one lead and other leads in said sample,
holding a relationship between said first position and said second position as a correction amount for said at least one lead,
calculating a third position of said at least one lead by way of using an image obtained by collectively imaging a plurality of leads that include said at least one lead and other leads in said object to be detected, and
calculating a fourth position of said at least one lead based upon said third position and said correction amount

2. The image processing method according to claim 1, wherein a specified region that involves said center point of said visual field is illuminated by a light source during performances of said imaging.

3. An image processing device comprising:
an imaging device which images an electronic component that includes leads,
and a calculation processing section which detects positions of a plurality of said leads in an object to be detected based upon an image obtained by imaging said electronic component which is a sample and upon an image obtained by imaging said electronic component which is said object to be detected, said image processing device further comprising:
a means that calculates a first position of at least one lead among leads in said sample by way of using an image acquired with said at least one lead disposed in a specified region that involves a center point of a visual field of said imaging device,
a means that calculates a second position of said at least one lead by way of using an image obtained by collectively imaging a plurality of leads that include said at least one lead and other leads in said sample,
a means that holds a relationship between said first position and said second position as a correction amount for said at least one lead,
a means that calculates a third position of said at least one lead by way of using an image obtained by collectively imaging a plurality of leads that include said at least one lead and other leads in said object to be detected, and
a means that calculates a fourth position of said at least one lead based upon said third position and said correction amount

4. The image processing device according to claim 3, further comprising a light source that illuminates a specified region that involves said center point of said visual field during performances of said imaging.
